(19) United States
(12) Patent Application Publication
(10) Pub. No.: US 2005/0209817 A1
(43) Pub. Date: Sep. 22, 2005

(54) Method and system for grading the internal condition of a pipe

(75) Inventors: Vani S. Kathula, San Jose, CA (US); Reginald L. Rowe, Montgomery, AL (US)

Correspondence Address: PERKINS COIE LLP;PATENT-SEA, P.O. BOX 1247, SEATTLE, WA, 98111-1247, US

(73) Assignee: CH2M HILL, Inc., Englewood, CO (US)

(21) Appl. No.: 10/823,036

(22) Filed: Apr. 12, 2004

Related U.S. Application Data
(60) Provisional application No. 60/554,104, filed on Mar. 17, 2004.

(51) Int. Cl. G06F 17/18

(52) U.S. Cl. 702/179; 702/35; 700/110

(57) ABSTRACT

A method and system for ascertaining the overall internal conditions of pipes. A grading system calculates a grade for each pipe that is in the range of 1 to 100, which represents its overall condition. The system then calculates a defect type score for each defect type that factors in the severity of the defect type and the extent of the defects of that defect type. The system then combines the defect type scores of the defect types to generate an overall score for the internal condition of the pipe.

### CROSS-REFERENCE TO RELATED APPLICATION

This application claims the benefit of U.S. Provisional Patent Application No. 60/554,104 filed Mar. 17, 2004, which is incorporated herein by reference in its entirety.

### TECHNICAL FIELD

The described technology relates generally to evaluating defects within a pipe.

### BACKGROUND

A wastewater management utility may have many hundreds of miles of underground pipes for the conveyance of wastewater. The quality of these pipes deteriorates over time for various reasons. For example, a pipe may have sediment build up at the bottom, may develop cracks due to shifting soil (e.g., earthquakes), may have manufacturing flaws, and so on. Indeed, one pipe may have many different defects. For example, a pipe may have a crack that extends longitudinally along 25% of the pipe, may have multiple perforations along the bottom of the pipe, and may have two cracks extending circumferentially around the pipe. A utility needs to monitor the condition of its pipes and maintain (i.e., repair and replace) the pipes as necessary. Because different pipes may deteriorate at different rates and may have been in service for different lengths of times, the utility needs to prioritize its maintenance or renewal activities based, in whole or in part, on the condition of the pipes.

Many different techniques have been developed for ascertaining the condition of a pipe. Typically, the condition of a pipe may be ascertained using closed-circuit television techniques, sonar techniques, sanitary sewer evaluation techniques, and so on. With such techniques, an inspector may observe the interior of a pipe, describe the defects, and assign a score to each defect. A score for a defect is intended to represent the relative condition, severity, remaining life, urgency, or priority that the defect presents to the intended function of the pipe. A score may be based on empirical and heuristic criteria. Various industry organizations provide scoring methodologies that score defects within a range from a lower limit to some upper limit, such as 1-5, 1-100, 100-10,000, or other numeric range. A low value within the range represents a minor defect, and the upper limit represents the most severe defect, which means that the pipe has failed to perform as intended.

To represent the overall condition of a pipe, an overall score is typically derived from the scores of the individual defects. For example, the overall score may be set to the highest score of a defect, the average of the scores of the defects, or the sum of the scores of the defects. (The term “pipe” as used herein refers to any portion of a conduit. A pipe may be a part of a joint-to-joint section, a full joint-to-joint section, a manhole-to-manhole segment, multiple manhole-to-manhole segments, and so on.) Each of these existing techniques for deriving an overall score for the condition of a pipe may fail to accurately represent the true condition of a pipe in certain situations. The highest and the average score techniques tend to understate the condition of the pipe when a pipe has many similar defects. In contrast, the sum of the scores technique tends to overstate the condition of the pipe when the pipe has many minor defects. If a utility cannot provide an accurate assessment of the condition of its pipes, it cannot accurately prioritize repair and maintenance. As a result, urgent repairs may be deferred in favor of routine maintenance.

It would be desirable to have a technique for accurately assessing the overall condition of a pipe so those pipes whose condition requires urgent attention can be given the highest priority.

### BRIEF DESCRIPTION OF THE DRAWINGS

FIG. 1 is a block diagram illustrating terminology used to describe a pipe.

FIG. 2 is a block diagram illustrating components of the grading system in one embodiment.

FIG. 3 is a flow diagram illustrating the processing of the calculate internal grade component in one embodiment.

FIG. 4 is a flow diagram illustrating the processing of the calculate defect type scores component in one embodiment.

FIG. 5 is a flow diagram illustrating the processing of the calculate defect grade component in one embodiment.

### DETAILED DESCRIPTION

A method and system for ascertaining the overall internal conditions of pipes is provided. In one embodiment, a grading system calculates a grade for each pipe that is in the range of 1 to 100, which represents its overall condition. The system receives defect types and extents of defect types (e.g., length or number of occurrences) based on one or more defects of a pipe. The system then calculates a defect type score for each defect type that factors in the severity of the defect type and the extent of the defects of that defect type. For example, a defect type that is not particularly severe may have a defect type score between 10 and 30 depending on its extent, whereas a more severe defect type may have a defect type score between 50 and 90 depending on its extent. The defect type score represents a cumulative score for all the defects of that defect type. The system then combines the defect type scores by weighting each defect type score from the highest to the lowest by an increasingly lower weight such as based on a geometric progression or by using a root-mean-square approach to generate an overall score for the internal condition of the pipe.

In one embodiment, each defect type is classified by a defect category, a defect form, and a defect severity. For example, a longitudinal fracture crack has a defect category of “crack,” a defect form of “longitudinal,” and a defect severity of “fracture.” Each defect type belongs to a defect group of “maintenance” or “structural.” As their names suggest, a structural defect relates to a problem in the structure of the pipe, and a maintenance defect relates to a problem in maintenance of the pipe. For example, a longitudinal fracture crack is a structural defect, whereas 20% blocking settled debris is a maintenance defect.

To generate the defect type scores, the system initially assigns a base defect type score and a maximum defect type score, which are in the range of 1 to 100, to each possible defect type. For example, a defect type of longitudinal fracture crack may have a base defect type score of 15 and a maximum defect type score of 80. The base defect type score represents the score of a single defect of that defect type that has the minimum possible extent. For example, a longitudinal fracture will have a defect type score of at least 15. The maximum defect type score represents the score for defects of that defect type that have the maximum cumulative extent. For example, longitudinal fracture cracks will have a defect type score of at most 80. The maximum possible extent of a continuous defect may be the length of the pipe, and the minimum possible extent of a continuous defect may be the minimum length of such defect, such as one foot. A defect shorter than one foot may be considered to be a point defect. The system calculates the defect type score as varying between the base defect type score and the maximum defect type score according to a relationship of the defect extent to the maximum possible extent. For example, if the combined extents of longitudinal fracture cracks is 100 ft. and the extent of the pipe is 200 ft., then the defect type score for that defect type is between its base defect type score and its maximum defect type score (e.g., 15+(80−15)*100/200=47.5). In this way, the minimum and maximum contribution of a defect type's score to the overall score can be bounded based on the defect type.

The grading system calculates a grade, also known as “internal grade,” representing the overall internal condition of a pipe by combining the individual defect type scores. In one embodiment, the grading system calculates an overall score by weighting each defect type score geometrically less than the next higher defect type score. For example, if the defect type scores for a pipe are 80, 70, and 30, and the weight of each defect type score is only one-hundredth of the weight of the next higher defect type score, then the overall score might be 80.703 (i.e., 80*100⁰+70*100⁻¹+30*100⁻²). In this example, since the defect type scores range from 0 to 99, the overall scores range from 0 to 99.9999. . . . This scoring technique based on a geometric progression of one-hundredths generates a ranking of the pipe grades that ranks all pipes with a certain defect type score above all pipes that do not have a higher defect type score for any defect type. For example, a pipe with only one defect type with a score of 80 is ranked above a pipe with five defect types that each have a defect type score of 79. The overall score for the pipe with one type of defect would be 80, and the overall score for the pipe with the five types of defects would be 79.79797979, which is less than 80. If two pipes have the same defect type scores for their first few highest defect type scores, then the first different defect type score is used to rank the pipes. For example, a pipe with a defect type scores of 79, 79, 79, and 78 would be ranked above a pipe, with defect type scores of 79, 79, 79, 77 and 77, because 78 is larger than 77. One skilled in the art will appreciate that the same ranking of the pipes can be derived by sorting the pipes based on defect type score. The grading system may sort the pipes based on their highest defect type score, their second highest defect type score, third highest defect type score, and so on. As a result of this sorting, the example pipes discussed above would be ranked as 80; 79, 79, 79, 79, 79; 79, 79, 79, 78; and 79, 79, 79, 77, and 77.

In an alternate embodiment, the system uses a root-mean-square approach to combine the individual defect type scores. The system combines the highest defect type score and the average of all the other defect type scores. The system calculates the grade as the square root of the average of the square of the highest defect type score and the square of the average defect type score. Thus, the upper limit of the grade is the highest defect type score, and the lower limit of the grade is the highest defect type score divided by the square root of two. For example, if the highest defect type score is 50 and the average of all the other defect type scores is also 50, then the grade will be at the upper limit (e.g., 50). If the average of all the other defect type scores is 25, then the grade will be significantly lower (e.g., 39.5). If, however, there is only one type of defect, then the grade will be at the lower limit (e.g., 35.4). Thus, the grade represents a root-mean-square combination of the highest defect type score and of the average of the remaining defect type scores.

In one embodiment, the grading system evaluates defects that are grouped as structural or maintenance. The system calculates a structural defect grade by applying the root-mean-square approach to the structural defects. The system also calculates a maintenance defect grade by applying the root-mean-square approach to the maintenance defects. The system calculates the internal grade by applying a root-mean-square approach to all the defects, both structural and maintenance.

In an alternate embodiment, the grading system calculates an overall score by adding the highest defect type score with a secondary score that derived from the defect type scores of the remaining defect types so that the overall score is within a predefined limit such as 100. After calculating the defect type scores, the grading systems selects the highest defect type score and subtracts it from the predefined limit to give a maximum secondary score, which represents the maximum amount that can be added to the highest defect score type when calculating the overall score. For example, if the highest defect type score is 80 and the predefined limit is 100, then the maximum secondary score is 20. To calculate the secondary score, the grading system multiples the maximum secondary score by a secondary factor that is based on the remaining defect types (i.e., all those other than the one with the highest defect type score). For example, if the secondary factor is 0.5 and the maximum secondary score is 20, then the secondary score is 10, which would give an overall score of 90 (i.e., 80+20*0.5).

The grading system can calculate the secondary factor in a variety of ways. In one embodiment, the grading system uses a score-based secondary factor that is based on a magnitude of the remaining defect type scores such as the total of the remaining defect type scores. When using the score-based secondary factor, the grading system calculates the secondary factor to be a logarithm of the ratio of the total of the remaining defect type scores to the total of the maximum defect type scores of all defect types. For example, if the total of the remaining defect score types is 190 (e.g., remaining defect type scores of 80, 80, and 30), the total of the maximum defect score types is 3659, and a natural logarithm is used, then the secondary factor would be 0.639, which would give an overall score of 91.28 (i.e., 80+20*0.639). In another embodiment, the grading system uses a count-based secondary factor that is based on a logarithm of the ratio of the count of the remaining defect types to the total number of all defect types. For example, if the count of the remaining defect types is 3, the total number of all defect types is 59, and a natural logarithm is used, then the secondary factor would be 0.269, which would give an overall score of 85.4 (i.e., 80+20*0.269). The grading system may allow a secondary factor that is a combination of the score-based secondary factor and the count-based secondary factor. For example, if the score-based secondary factor of 0.639 and the count-based secondary factor of 0.269 are given equal weight, then the combined secondary factor would be 0.454 (i.e., 0.5*639+0.5*0.269), which would give an overall score of 89.08 (i.e., 80+20*0.454). The weights can be adjusted to give more or less weight to the score-based secondary factor or the count-based secondary factors. For example, weights of 0.8 and 0.2 may be given to the score-based secondary factor and count-based secondary factor, respectively, when a user believes that the score-based secondary factor provide a more accurate assessment of the condition of the pipe. This scoring technique can be used to calculate the structural grade, maintenance grade, and overall internal grade of a pipe.

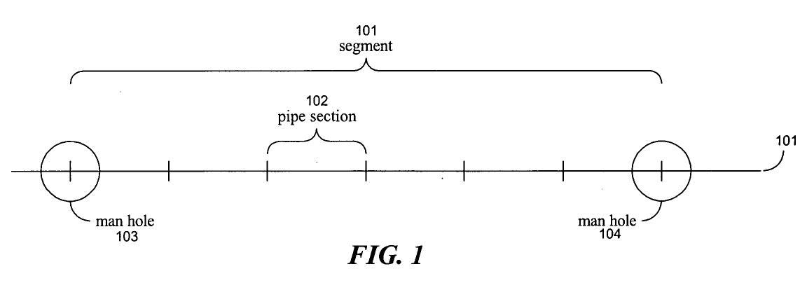

FIG. 1 is a block diagram illustrating terminology used to describe a pipe. The pipe 100 includes a pipe segment 101 that is defined as a portion of the pipe that extends from manhole 103 to manhole 104. A pipe segment may contain pipe sections 102 that extend from pipe joint to pipe joint. In this example, the pipe segment has six pipe sections. Each defect within a pipe segment is identified by its defect type and start distance from either the upstream or downstream manhole. A continuous defect also includes a finish distance from the upstream or downstream manhole. For example, if each section is 50 ft., then a longitudinal hairline crack defect, which is a structural defect, may start at 110 ft. from the upstream manhole and finish at 140 ft. from the upstream manhole for an extent of 30 ft.

Table 1 defines various structural and maintenance defect types. Each entry of the table identifies a defect type by defect category, defect form, and defect severity and provides a corresponding definition. For example, the defect type of circumferential tight crack is defined as “crack visible on the pipe wall, pieces still in place, with 1 mm to 3 mm separation which is mainly around the circumference of the pipe or joint.”

TABLE 1

| Defect | Defect | Defect | |
|---|---|---|---|
| Category | Form | Severity | Definition |
| Crack | Longitudinal | Hairline | Crack with no or less than 1 mm separation, |
| | | | which is mainly parallel to the axis of the pipe |
| | | Tight | Crack visible on the pipe wall, pieces still in |
| | | | place, with 1 mm to 3 mm separation and is |
| | | | mainly parallel to the axis of the pipe |
| | | Fracture | Crack visibly open in a pipe wall, pieces still in |
| | | | place, greater than 3 mm separation and is |
| | | | mainly parallel to the axis of the pipe |
| | Circumferential | Hairline | Crack with no or less than 1 mm separation, |
| | | | which is mainly around the circumference of the |
| | | | pipe or joint |
| | | Tight | Crack visible on the pipe wall, pieces still in |
| | | | place, with 1 mm to 3 mm separation which is |
| | | | mainly around the circumference of the pipe or |
| | | | joint |
| | | Fracture | Crack visibly open in a pipe wall, pieces still in |
| | | | place, with greater than 3 mm separation which |
| | | | is mainly around the circumference of the pipe or |
| | | | joint |
| | Multiple | Hairline | A group of cracks with no or less than 1 mm |
| | | | separation, which cannot be described as |
| | | | longitudinal or circumferential or are too |
| | | | numerous to code separately |
| | | Tight | A group of cracks visible on the pipe wall, pieces |
| | | | still in place, with 1 mm to 3 mm separation, |
| | | | which cannot be described as longitudinal or |
| | | | circumferential |
| | | Fracture | A group of cracks visibly open in a pipe wall, |
| | | | pieces still in place, greater than 3 mm |
| | | | separation, which cannot be described as |
| | | | longitudinal or circumferential |
| | Spiral | Hairline | Individual surface cracks that change position as |
| | | | they travel along the pipe |
| | | Tight | Individual cracks with 1 mm to 3 mm separation |
| | | | and that change position as they travel along the |
| | | | pipe or are too numerous to code separately |
| | | Fracture | Individual open cracks that are greater than 3 mm |
| | | | and change position as they travel along the |
| | | | pipe or are too numerous to code separately |
| Blockage | Roots | 10% | Root accumulation blocks up to 10% of mainline |
| | | restriction | cross section |
| | | 20% | Root accumulation blocks up to 20% of mainline |
| | | restriction | cross section |
| | | 30% | Root accumulation blocks up to 30% of mainline |
| | | restriction | cross section |
| | | 40% | Root accumulation blocks up to 40% of mainline |
| | | restriction | cross section |
| | | 50% | Root accumulation blocks up to 50% of mainline |
| | | restriction | cross section |
| | | 60% | Root accumulation blocks up to 60% of mainline |
| | | restriction | cross section |
| | | 70% | Root accumulation blocks up to 70% of mainline |
| | | restriction | cross section |
| | | 80% | Root accumulation blocks up to 80% of mainline |
| | | restriction | cross section |
| | | 90% | Root accumulation blocks up to 90% of mainline |
| | | restriction | cross section |
| | | 100% | Root accumulation blocks up to 100% of |
| | | restriction | mainline cross section |
| | Settled | 10% | Settled deposit accumulation blocks up to 10% |
| | Deposits | restriction | of mainline cross section |
| | (Debris) | 20% | Settled deposit accumulation blocks up to 20% |
| | | restriction | of mainline cross section |
| | | 30% | Settled deposit accumulation blocks up to 30% |
| | | restriction | of mainline cross section |
| | | 40% | Settled deposit accumulation blocks up to 40% |
| | | restriction | of mainline cross section |
| | | 50% | Settled deposit accumulation blocks up to 50% |
| | | restriction | of mainline cross section |
| | | 60% | Settled deposit accumulation blocks up to 60% |
| | | restriction | of mainline cross section |
| | | 70% | Settled deposit accumulation blocks up to 70% |
| | | restriction | of mainline cross section |
| | | 80% | Settled deposit accumulation blocks up to 80% |
| | | restriction | of mainline cross section |
| | | 90% | Settled deposit accumulation blocks up to 90% |
| | | restriction | of mainline cross section |
| | | 100% | Settled deposit accumulation blocks up to 100% |
| | | restriction | of mainline cross section |

Table 2 provides example defect profiles for some structural and maintenance defects. Each entry of the table identifies a defect type by defect category, defect form, and defect severity and includes its base and maximum defect type scores. For example, the defect type of circumferential tight crack has a base defect type score of 6 and a maximum defect type score of 70. Each entry also identifies whether the defect type is continuous or point. For example, the circumferential defect forms are point types. The maximum extent for defects with a continuous defect type is the length of the segment (“SPL”), and the maximum extent for defects with a point defect type is the number of sections within the segment (i.e., SPL/PJL where “PJL” is the length of a section). Although not shown in Table 2, the base defect type score and maximum defect type score may be different for pipes of different materials (e.g., concrete, clay, brick, PVC and metals such as iron and steel). For example, the base defect type score for a longitudinal hairline crack may be 1 for a concrete pipe and 50 for a PVC pipe.

TABLE 2

| | | | | | | Base | Maximum | |
|---|---|---|---|---|---|---|---|---|
| | | | | | | Defect | Defect | |
| | | | | | | Type | Type | |
| Defect | Defect | Defect | Defect | | | Score | Score | Maximum |
| Category | Form | Severity | Group | Continuous | Unit | (BDS) | (MDS) | Extent |
| Crack | Longitudinal | Hairline | Structural | Yes | Feet | 1 | 20 | SPL |
| | | Tight | Structural | Yes | Feet | 6 | 50 | SPL |
| | | Fracture | Structural | Yes | Feet | 15 | 80 | SPL |
| | Circumferential | Hairline | Structural | No | Each | 1 | 30 | SPL/PJL |
| | | Tight | Structural | No | Each | 6 | 70 | SPL/PJL |
| | | Fracture | Structural | No | Each | 20 | 85 | SPL/PJL |
| | Multiple | Hairline | Structural | Yes | Feet | 2 | 40 | SPL |
| | | Tight | Structural | Yes | Feet | 10 | 70 | SPL |
| Blockage | Roots | 10% | Maintenance | No | Each | 1 | 10 | SPL/PJL |
| | | Restriction | | | | | | |
| | | 20% | Maintenance | No | Each | 2 | 20 | SPL/PJL |
| | | Restriction | | | | | | |
| | | 30% | Maintenance | No | Each | 3 | 30 | SPL/PJL |
| | | Restriction | | | | | | |
| | Settled | 10% | Maintenance | Yes | Feet | 1 | 10 | SPL |
| | Deposits | Restriction | | | | | | |
| | (Debris) | 20% | Maintenance | Yes | Feet | 2 | 20 | SPL |
| | | Restriction | | | | | | |
| | | 30% | Maintenance | Yes | Feet | 3 | 60 | SPL |
| | | Restriction | | | | | | |

Table 3 provides example defect data collected during inspection of a pipe segment. Each entry identifies the defect type, start distance, and finish distance. For example, the second entry indicates that a structural defect with a defect type of circumferential tight crack is located at a distance 250 ft. from the upstream manhole. The start and finish distances are used to calculate the length of a continuous defect. For example, a longitudinal tight crack has two entries with a total combined length of 105 feet. Each point defect type has an entry for each occurrence of that defect type. For example, the small irregular hole defect type has occurrences at 25 feet and 50 feet.

TABLE 3

| | | | Defect | |
|---|---|---|---|---|
| | | | Start | Defect Finish |
| Defect | | | Distance | Distance |
| Category | Defect Form | Defect Severity | (in feet) | (in feet) |
| Crack | Longitudinal | Tight | 120.00 | 200.00 |
| Crack | Longitudinal | Tight | 50.00 | 75.00 |
| Crack | Circumferential | Tight | 250.00 | — |
| Blockage | Settled Deposit | 20% restriction | 250.00 | 300.00 |
| | Debris | | | |
| Hole | Irregular | Small | 25.00 | |
| Hole | Irregular | Small | 50.00 | |

The information of Table 2 and Table 3 is used to calculate the structural, maintenance, and internal grade of a pipe. The system calculates the defect type score for a continuous defect using the following equation:

$${DS}_{{C}_{t}} = {BDS}_{t} + \{ ( {MDS}_{t} - {BDS}_{t} ) ( \frac{{DL}_{t}}{SPL} ) \} \qquad ( 1 )$$

where DS_{C}_{ₜ} is the defect type score for the continuous defect type t of the segment, BDSₜ is the base defect type score for the defect type t, MDSₜ is the maximum defect type score for the defect type t, DLₜ is the total length (or extent) of the continuous defects (limited to the segment length) of defect type t, and SPL is the segment length (or maximum extent).

The system calculates the defect type score for a point defect using the following equation:

$${DS}_{{P}_{t}} = {BDS}_{t} + \{ ( {MDS}_{t} - {BDS}_{t} ) ( \frac{min ( {ND}_{t} , {TDC}_{t} )}{{TDC}_{t}} ) \} \qquad ( 2 )$$

where DS_{P}_{ₜ} is the defect type score for the point defect type t of the segment, BDSₜ is the base defect type score for the defect type t, MDSₜ is the maximum defect type score for the defect type t, NDₜ is the total number (or extent) of the point defect type t (limited to the maximum number), and TDCₜ is the maximum number (or maximum extent) of the point defect type t.

The system calculates the structural defect grade for a pipe segment using the following equation:

$${SDG}_{g} = {\sum }_{t = 1}^{m} \frac{{DS}_{t}}{{( 100 )}^{t - 1}} \qquad ( 3 a )$$

where SDG_{g} represents the structural defect grade based on a geometric weighting, DSₜ is the defect type score for a continuous or point defect type t (DS_{C}_{ₜ} or DS_{P}_{ₜ}) in the structural defect group (the grade may be calculated for continuous defects only, point defects only, or a combination of continuous and point defects), and m represents all the structural defect scores ordered from highest to lowest defect type score; or

$${SDG}_{rms} = \sqrt{\frac{max {DS}^{2} + {[ \frac{1}{n} {\sum }_{t = 1}^{n} {DS}_{t} ]}^{2}}{2}} \qquad ( 3 b )$$

where SDGᵣₘₛ represents the structural defect grade using the root-mean-square approach, DSₜ is the defect type score for a continuous or point defect type t (DS_{C}_{ₜ} or DS_{P}_{ₜ}) in the structural defect group, maxDS represents the highest defect type score within DSₜ, and n represents the total number of the structural defect types except the one with the highest score (e.g., in Table 2, 8 structural defect types are defined so n would be 7).

The system calculates the maintenance defect grade for a pipe segment using the following equation:

$${MDG}_{g} = {\sum }_{t = 1}^{m} \frac{{DS}_{t}}{{( 100 )}^{t - 1}} \qquad ( 4 a )$$

where MDG_{g} represents the maintenance defect grade based on a geometric weighting, DSₜ is the defect type score for a continuous or point defect type t (DS_{C}_{ₜ} or DS_{P}_{ₜ}) in the maintenance defect group (the grade may be calculated for continuous defects only, point defects only, or a combination of continuous and point defects), and m represents all the maintenance defects ordered from highest to lowest defect type score; or

$${MDG}_{rms} = \sqrt{\frac{max {DS}^{2} + {[ \frac{1}{n} {\sum }_{t = 1}^{n} {DS}_{t} ]}^{2}}{2}} \qquad ( 4 b )$$

where MDGᵣₘₛ represents the maintenance defect grade using the root-mean-square approach, DSₜ is the defect type score for a continuous or point defect type t (DS_{C}_{ₜ} or DS_{P}_{ₜ}) in the maintenance defect group, maxDS represents the highest defect type score within DSₜ, and n represents all the maintenance defects except the one with the highest score (e.g., if there are 20 maintenance defect types, then n is 19.

The system calculates the pipe segment internal grade using the following equation:

$${PSIG}_{g} = {\sum }_{t = 1}^{m} \frac{{DS}_{t}}{{( 100 )}^{t - 1}} \qquad ( 5 a )$$

where PSIG_{g} represents the pipe segment internal grade based on a geometric weighting, DSₜ is the defect type score for a continuous or point defect type t (DS_{C}_{ₜ} or DS_{P}_{ₜ}) in the pipe segment (the grade may be calculated for continuous defects only, point defects only, or a combination of continuous and point defects), and m represents all the structural and maintenance defects ordered from highest to lowest defect type score; or

$${PSIG}_{rms} = \sqrt{\frac{max {DS}^{2} + {[ \frac{1}{n} {\sum }_{t = 1}^{n} {DS}_{t} ]}^{2}}{2}} \qquad ( 5 b )$$

where PSIGᵣₘₛ represents the pipe segment internal grade using the root-mean-square approach, DSₜ is the defect type score for a continuous or point defect type t (DS_{C}_{ₜ} or DS_{P}_{ₜ}) (the grade may be calculated for continuous defects only, point defects only, or a combination of continuous and point defects), maxDS represents the highest defect type score within DSₜ, and n represents all the defects, structural and maintenance, except the one with the highest score.

In one embodiment, the grading system may calculate structural, maintenance, and pipe segment internal scores by initially calculating primary scores using the root-mean-square equations 3b, 4b, and 5b. For each group of pipes that has the same highest defect type score, the grading system then calculates scores using the root-mean-square equation using all but the highest score. The scores provide a secondary ranking of the pipes within each group. The grading system then adjusts the primary scores for the pipes within each group so that the primary rankings for the pipes within the group reflect the secondary rankings, while maintaining the same primary ranking relative to pipes in other groups. The primary scores for a group are kept between the lowest and highest primary scores of the range that were initially calculated. Moreover, the grading system may give a pipe an adjusted primary score within the primary range that is the same fraction of the primary range as its secondary score is of the secondary range. For example, a pipe with a secondary score that is lowest within the secondary range has its primary score set to the lowest within the primary range regardless of where its primary score was originally within the primary range, and a pipe with a secondary score that is at the midpoint of the secondary range has its primary score set to the midpoint of the primary range regardless of where its primary score was originally. If the primary scores for a group of three pipes with the same highest defect type score are 57.2, 57.4, 57.6 and the secondary scores for those pipes are 52, 56, and 53, respectively, then the primary score of 57.2 might not be adjusted because its secondary score of 52 is lowest in the secondary range and its already the lowest in the primary range, the primary score of 57.4 might be adjusted to 57.6 because its secondary score of 56 is highest in the secondary range, and the primary score of 57.6 might be adjusted to 57.3, which is one-sixth the way from the lowest to the highest primary score of the primary range because its secondary score is one-sixth the way within the secondary range. This process of calculating root-mean-square scores and adjusting the primary scores can continue for tertiary scores for groups that share the same two highest defect type scores, quaternary scores for groups that have the same three highest defect type scores, and so on.

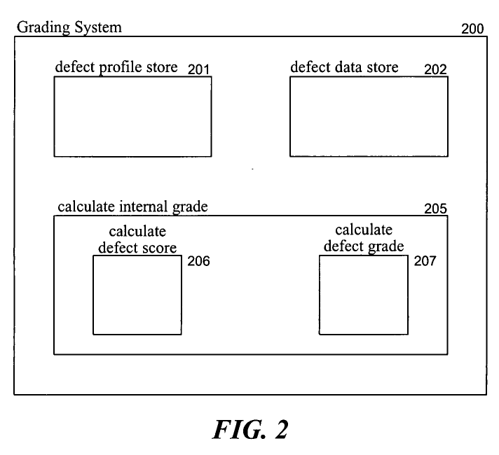

FIG. 2 is a block diagram illustrating components of the grading system in one embodiment. The grading system 200 includes a defect profile store 201, a defect data store 202, and a calculate internal grade component 205. The defect profile store contains the base and maximum defect type scores and corresponds to Table 2. The defect data store contains the information describing each defect and corresponds to Table 3. The calculate internal grade component includes a calculate defect type scores component 206 and a calculate defect grade component 207. The calculate internal grade component invokes the calculate defect type score component and the calculate defect grade component to calculate the internal grade.

The grading system may be implemented on a computer system that includes a central processing unit, memory, input devices (e.g., keyboard and pointing devices), output devices (e.g., display devices), and storage devices (e.g., disk drives). The memory and storage devices are computer-readable media that may contain instructions that implement the grading system. In addition, the data structures may be stored or transmitted via a data transmission medium, such as a signal on a communications link. Various communications links may be used, such as the Internet, a local area network, a wide area network, or a point-to-point dial-up connection. For example, the defect information may be collected from remote sites and stored in a central database.

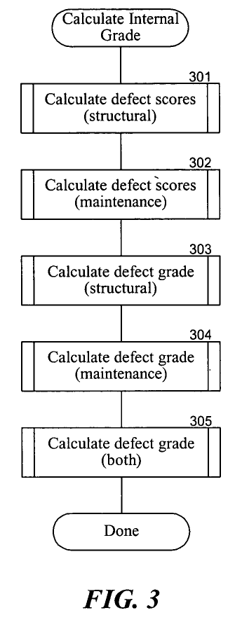

FIG. 3 is a flow diagram illustrating the processing of the calculate internal grade component in one embodiment. In block 301, the component invokes the calculate defect type scores component passing an indication that the defect type scores for the defects in the structural defect group are to be calculated. In block 302, the component invokes the calculate defect type scores component passing an indication that the defect type scores for the defects in the maintenance defect group are to be calculated. In block 303, the component invokes the calculate defect grade component passing an indication that the structural defect grade is to be calculated. In block 304, the component invokes the calculate defect grade component passing an indication that the maintenance defect grade is to be calculated. In block 305, the component invokes the calculate defect grade component passing an indication that an overall internal grade is to be calculated based on defects in both the structural and the maintenance groups.

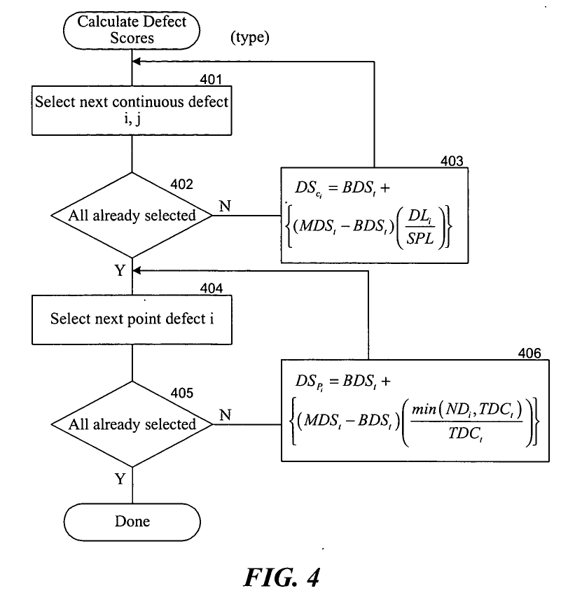

FIG. 4 is a flow diagram illustrating the processing of the calculate defect type scores component in one embodiment. This component implements the processing defined by equations 1 and 2. In blocks 401-403, the component calculates the defect type score for each defect type of continuous defects. In block 401, the component selects the next continuous defect type. In decision block 402, if all the continuous defect types have already been selected, then the component continues at block 404, else the component continues at block 403. In block 403, the component calculates the defect type score for the selected continuous defect type according to equation 1 and then loops to block 401 to select the next continuous defect type. In blocks 404-406, the component calculates the defect type scores for the point defect types. In block 404, the component selects the next point defect type. In decision block 405, if all the point defect types have already been selected, then the component completes, else the component continues at block 406. In block 406, the component calculates the defect type score for the selected point defect type according to equation 2 and then loops to block 404 to select the next point defect type.

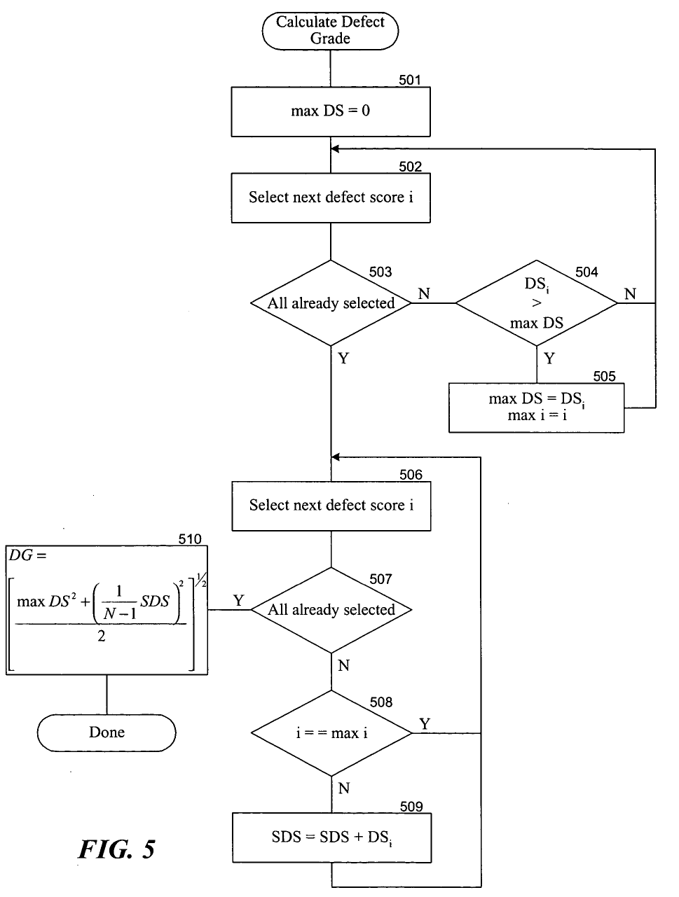

FIG. 5 is a flow diagram illustrating the processing of the calculate defect grade component in one embodiment. The component is passed an indication of the defect group for which the defect grade is to be calculated. The defect group may be structural, maintenance, or both. In block 501, the component initializes a highest defect type score variable to zero. In blocks 502-505, the component loops identifying the highest defect type score for the passed defect group. In block 502, the component selects the next defect type for the passed defect group. In decision block 503, if all the defect type scores have already been selected, then the component continues at block 506, else the component continues at block 504. In decision block 504, if the defect type score of the selected defect type is greater than the highest defect type score encountered so far, then the component continues at block 505, else the component loops to block 502 to select the next defect type. In block 505, the component sets the highest defect type score to the defect type score of the selected defect type and sets the highest index to indicate the index of the selected defect type. In blocks 506-509, the component loops summing up the defect type scores for all the defect types of the passed defect group, except the one with the highest defect type score. In block 506, the component selects the next defect type of the passed defect group. In decision block 507, if all the defect types have already been selected, then the component continues at block 510, else the component continues at block 508. In decision block 508, if the selected defect type is the defect type with the highest defect type score, then the component excludes it from the summation and loops to block 506 to select the next defect type, else the component continues at block 509. In block 509, the component adds the defect type score of the selected defect type to the sum of the defect type scores and loops to block 506 to select the next defect type. In block 510, the component calculates the defect grade in accordance with equations 3, 4, or 5. The component then completes.

One skilled in the art will appreciate that although specific embodiments of the grading system have been described herein for purposes of illustration, various modifications may be made without deviating from the spirit and scope of the invention. For example, one skilled in the art would appreciate that the components of the grading system may be implemented using a standard spreadsheet program, database program (e.g., MICROSOFT ACCESS and SQL), and so on. One skilled in the art will also appreciate that the scores for a defect may vary linearly or non-linearly between the base defect type score and the maximum defect type score for a defect type based on the extent of the defect. For example, a score may asymmetrically approach the maximum defect type score as the extent increases. One skilled in the art will also appreciate that the designation of what constitutes a defect can vary widely, as can the typing of defects. For example, two longitudinal cracks could be classified as one defect or two defects depending on their relationships. One skilled in the art will appreciate that the term pipe includes conduits and appurtenances of the conduits. The conduits may be used to conduct stormwater, wastewater, sanitary water, and potable water, and with combined sewer systems. The appurtenances may include storm inlet and outlet structures, manholes, and culverts. One skilled in the art will also appreciate that the described system may be used to grade the external condition of a pipe. Accordingly, the invention is not limited except by the appended claims.

1. A method for scoring a defect type of a pipe, the method comprising:
receiving a defect type and an extent for the defect type of a pipe based on at least one defect of the pipe;
providing a base defect type score, a maximum defect type score, and a maximum extent that is specific to the defect type; and
calculating a score for the defect type that is between the base defect type score and the maximum defect type score based on a relationship between the extent of the defect type and the maximum extent of the defect type.

2. The method of claim 1 wherein the relationship is a ratio of the received extent of the defect type to the maximum extent of the received defect type.

3. The method of claim 1 wherein the defect type is a continuous defect type and the maximum extent is segment length.

4. The method of claim 3 wherein the received extent of the defect type is the length of the continuous defect of that defect type.

5. The method of claim 3 wherein the score is calculated as follows:
$${DS}_{{C}_{t}} = {BDS}_{t} + \{ ( {MDS}_{t} - {BDS}_{t} ) ( \frac{{DL}_{t}}{SPL} ) \}$$
where DS_{C}_{ₜ} is the defect type score for the continuous defect type t of the pipe, BDSₜ is the base defect type score for the defect type t, MDSₜ is the maximum defect type score for the defect type t, DLₜ is the extent of the continuous defect type t, and SPL is the maximum extent for the defect type t.

6. The method of claim 1 wherein the defect type is a point defect type and the maximum extent is a number of occurrences of the defect type.

7. The method of claim 6 wherein the maximum extent is a number of sections in the pipe.

8. The method of claim 6 wherein the received extent of the defect type is the number of occurrences of defects of that defect type.

9. The method of claim 6 wherein the score is calculated as follows:
$${DS}_{{P}_{t}} = {BDS}_{t} + \{ ( {MDS}_{t} - {BDS}_{t} ) ( \frac{min ( {ND}_{t} , {TDC}_{t} )}{{TDC}_{t}} ) \}$$
where DS_{P}_{ₜ} is the defect type score for the point defect type t of the pipe, BDSₜ is the base defect type score for the defect type t, MDSₜ is the maximum defect type score for the defect type t, NDₜ is the extent of the point defect type t, and TDCₜ is the maximum extent for the defect type t.

10. The method of claim 1 wherein the defect type has a defect category, defect form, and defect severity.

11. The method of claim 10 wherein the defect categories include crack.

12. The method of claim 10 wherein the defect forms include longitudinal, circumferential, multiple, and spiral.

13. The method of claim 10 wherein the defect severities include hairline, tight, and fracture.

14. The method of claim 1 wherein the defect type has a defect group.

15. The method of claim 14 wherein the defect groups include structural and maintenance.

16. The method of claim 1 wherein a defect type score ranges from 0 to 100.

17. The method of claim 1 wherein the base defect type score and the maximum defect type score vary based on material of the pipe.

18. The method of claim 17 wherein the material is concrete, clay, brick, PVC, or metal.

19. The method of claim 1 wherein a base defect type score, a maximum defect type score, and maximum extent are provided for each of a plurality of defect types and the received defect type is one of the plurality of defect types.

20. The method of claim 1 wherein the defect type score is based on multiple defects of that defect type.

21. The method of claim 20 wherein the sum of the extent of a defect type is the extent of each defect of that type limited to the maximum extent for that defect type.

22. A method for grading a pipe having defects, the method comprising:
providing a defect type score for each defect type of the pipe; and
calculating a grade for the pipe that is based on a root-mean-square combination of a highest defect type score of the defect types and an average defect type score of the remaining defect types.

23. The method of claim 22 wherein the calculating includes taking the square root of the average of the square of the highest defect type score and the square of the average defect type score.

24. The method of claim 22 wherein the grading is calculated as follows:
$$SDG = \sqrt{\frac{max {DS}^{2} + {[ \frac{1}{n} {\sum }_{t = 1}^{n} {DS}_{t} ]}^{2}}{2}}$$
where SDG represents a structural defect grade, DSₜ is the defect type score for a continuous or point defect type t within the structural defect group, maxDS represents the highest defect type score within DSₜ, and n represents the number of all the structural defect types except the one with the highest defect type score.

25. The method of claim 22 wherein the defect types include continuous and point defect types.

26. The method of claim 22 wherein the defect types are in a defect group of structural.

27. The method of claim 22 wherein the defect types are in a defect group of maintenance.

28. The method of claim 22 wherein the defect types are in a defect group of structural or maintenance.

29. The method of claim 22 wherein the grade is a pipe internal grade.

30. The method of claim 22 wherein the grading is calculated as follows:
$$MDG = \sqrt{\frac{max {DS}^{2} + {[ \frac{1}{n} {\sum }_{t = 1}^{n} {DS}_{t} ]}^{2}}{2}}$$
where MDG represents a maintenance defect grade, DSₜ is the defect type score for a continuous or point defect type t in a defect group of maintenance, maxDS represents the highest defect type score within DSₜ, and n represents the number of maintenance defect types except the one with the highest defect type score.

31. The method of claim 22 wherein the grading is calculated as follows:
$$IDG = \sqrt{\frac{max {DS}^{2} + {[ \frac{1}{n} {\sum }_{t = 1}^{n} {DS}_{t} ]}^{2}}{2}}$$
where IDG represents an overall internal defect grade of the pipe, DSₜ is the defect type score for a continuous or point defect type t, maxDS represents the highest defect type score within DSₜ, and n represents the number of defect types except the one with the highest defect type score.

32. The method of claim 31 wherein the defect types are in structural and maintenance defect groups.

33. The method of claim 22 wherein the providing of a defect type score includes:
providing a base defect type score, a maximum defect type score, and a maximum extent for each defect type;
receiving a defect type and an extent of each defect of the received defect type; and
calculating a score for the defect type that is between the base defect type score and the maximum defect type score for the received defect type based on a relationship between a sum of the received extents of the defects and the maximum extent of the received defect type.

34. The method of claim 22 wherein the calculated grade is a primary grade including:
calculating a secondary grade for each pipe in a group of pipes having the same highest defect type score; and
adjusting the primary grade for the pipes in the group based on the calculated secondary grades.

35. The method of claim 34 wherein the calculating and adjusting is repeated for each group of pipes that have the same set of highest defect type scores.

36. The method of claim 34 wherein the adjusted primary grades are within the lowest and highest primary grades initially calculated.

37. The method of claim 34 wherein the primary grade of a pipe within the group is adjusted such that its value is the same fraction of the way from the lowest to the highest primary grade of the group as is its secondary grade is the way from the lowest to the highest secondary grade of the group.

38. The method of claim 22 wherein a pipe includes conduit and appurtenances.

39. The method of claim 22 wherein a pipe includes a conduit for stormwater or wastewater.

40. The method of claim 22 wherein the pipe includes a manhole.

41. A computing system for grading a pipe having defects, comprising:
a component that calculates a defect type score for each defect type of the pipe that is between a base defect type score and a maximum defect type score that is specific to the defect type based on a relationship between a sum of the extents of the defects of the defect type and a maximum extent for the defect type; and
a component that calculates a grade for the pipe that is based on a combination of a highest defect type score of the defect type and an average defect type score of the remaining defect types.

42. The computer system of claim 41 wherein the combination is a root-mean-square combination.

43. The computer system of claim 41 wherein the calculating of the defect type score includes:
providing the base defect type score, the maximum defect type score, and the maximum extent for each defect type; and
receiving the extent for each defect of each defect type.

44. The computer system of claim 41 wherein the calculating of the defect type score includes taking the square root of the average of the square of a highest defect type score and the square of the average defect type score of the defect type scores except the highest defect type score.

45. The computer system of claim 41 wherein the grade is calculated as follows:
$$IDG = \sqrt{\frac{max {DS}^{2} + {[ \frac{1}{n} {\sum }_{t = 1}^{n} {DS}_{t} ]}^{2}}{2}}$$
where IDG represents the overall internal defect grade of the pipe, DSₜ is the defect type score for a continuous or point defect type t, maxDS represents the highest defect type score of DSₜ, and n represents the number of defect types except the one with the highest defect type score.

46. The computer system of claim 41 wherein the base defect type score and the maximum defect type score for a defect type vary based on material of the pipe.

47. The computer system of claim 46 wherein the material is concrete, clay, brick, PVC, or metal.

48. The computer system of claim 41 wherein the defect type score for a continuous defect is calculated as follows:
$${DS}_{{C}_{t}} = {BDS}_{t} + \{ ( {MDS}_{t} - {BDS}_{t} ) ( \frac{{DL}_{t}}{SPL} ) \}$$
where DS_{C}_{ₜ} is the defect type score for the continuous defect type t of the pipe, BDSₜ is the base defect type score for the defect type t, MDSₜ is the maximum defect type score for the defect type t, DLₜ is the total extent of the continuous defects of the defect type t, and SPL is the maximum extent of the defect type t.

49. The computer system of claim 41 wherein the defect type score for a point defect is calculated as follows:
$${DS}_{{P}_{t}} = {BDS}_{t} + \{ ( {MDS}_{t} - {BDS}_{t} ) ( \frac{min ( {ND}_{t} , {TDC}_{t} )}{{TDC}_{t}} ) \}$$
where DS_{P}_{ₜ} is the defect type score for the point defect type t of the pipe, BDSₜ is the base defect type score for the defect type t, MDSₜ is the maximum defect type score for the defect type t, NDₜ is the total extent of the point defects of defect type t, and TDCₜ is the maximum extent of the point defect type t.

50. A method for grading a pipe having defects, the method comprising:
providing a defect type score for each defect type of the pipe; and
calculating a grade for the pipe that is based on a geometrically smaller weight being used from the highest defect type score to the lowest defect type score of the pipe.

51. The method of claim 50 wherein each weight is one-hundredth of the weight of the next higher grade.

52. The method of claim 50 wherein the grading is calculated as follows:
$${SDG}_{g} = {\sum }_{t = 1}^{m} \frac{{DS}_{t}}{{( 100 )}^{t - 1}}$$
where SDG_{g} represents the structural defect grade based on a geometric weighting, DSₜ is the defect type score for a continuous or point defect of the defect type t (DS_{C}_{ₜ} or DS_{P}_{ₜ}) in the structural defect group, and m represents all the structural defect types ordered from highest to lowest defect type score.

53. The method of claim 50 wherein the grading is calculated as follows:
$${MDG}_{g} = {\sum }_{t = 1}^{m} \frac{{DS}_{t}}{{( 100 )}^{t - 1}}$$
where MDG_{g} represents the maintenance defect grade based on a geometric weighting, DSₜ is the defect type score for a continuous or point defect type t (DS_{C}_{ₜ} or DS_{P}_{ₜ}) in the maintenance defect group, and m represents all the maintenance defect types ordered from highest to lowest defect type score.

54. The method of claim 50 wherein the grading is calculated as follows:
$${PSIG}_{g} = {\sum }_{t = 1}^{m} \frac{{DS}_{t}}{{( 100 )}^{t - 1}}$$
where PSIG_{g} represents the pipe segment internal grade based on a geometric weighting, DSₜ is the defect type score for a continuous or point defect type t (DS_{C}_{ₜ} or DS_{P}_{ₜ}) in the pipe segment interval group, and m represents all the defect types ordered from highest to lowest defect type score.

55. The method of claim 50 wherein the pipes are ranked by sorting their defect type scores so that the pipes with the highest defect type scores are ranked first and, when pipes have the same highest defect type score, they are ranked relative to each other based on their second highest defect type scores.

56. A method for grading a pipe having defects, the method comprising:
providing a defect type score for each defect type of the pipe; and
calculating a grade for the pipe that is within a limit and that is based on a highest defect type score of the pipe combined with a secondary score derived from remaining defect type scores of the pipe.

57. The method of claim 56 wherein a maximum secondary score is the difference between the limit and the highest defect score type.

58. The method of claim 57 wherein the secondary score is calculated by multiplying the maximum secondary score by a secondary factor.

59. The method of claim 58 wherein the secondary factor is score-based.

60. The method of claim 59 wherein the score-based secondary factor is a logarithm of a ratio of a total of the defect type scores of the remaining defect types and a total of the maximum defect type scores of all defect types.

61. The method of claim 58 wherein the secondary factor is count-based.

62. The method of claim 61 wherein the score-based secondary factor is a logarithm of a ratio of a count of the remaining defect types and a total of all defect types.

63. The method of claim 58 wherein the secondary factor is a combination of a score-based secondary factor and a count-based secondary factor.
